(19) United States
(12) Patent Application Publication
(10) Pub. No.: US 2021/0354127 A1
(43) Pub. Date: Nov. 18, 2021

(54) RIBONUCLEIC ACID TEST PANEL AND RIBONUCLEIC ACID TEST DEVICE

(71) Applicant: KEYCORE TECHNOLOGY CORP., Zhubei City (TW)

(72) Inventors: Li-Ta Chiang, Zhubei City (TW); Po-Wei Chiu, Zhubei City (TW); Hsiang-Yu Fan, Zhubei City (TW); Shih-Hsiu Tseng, Zhubei City (TW); Chien-Jen Hsiao, Zhubei City (TW); Li-Ying Chang, Zhubei City (TW)

(21) Appl. No.: 15/931,529

(22) Filed: May 13, 2020

(51) Int. Cl. B01L 3/00

(52) U.S. Cl. CPC B01L 3/502715; B01L 2300/023; B01L 2300/0645; B01L 2300/0819

(57) ABSTRACT

A ribonucleic acid test panel and a ribonucleic acid test device. The ribonucleic acid test device includes a control unit and a ribonucleic acid test panel. The ribonucleic acid test panel includes a substrate, multiple sensation electrode layers electrically connected with the control unit, at least one primer layer and multiple electrode wiring layers. The multiple sensation electrode layers are disposed on a first surface of the substrate. The at least one primer layer is disposed on the multiple sensation electrode layers and insulated from each other. The multiple electrode wiring layers are electrically connected with the multiple sensation electrode layers and the control unit. By means of the design of the ribonucleic acid test device, the test time is shortened and the cost is lowered.

### BACKGROUND OF THE INVENTION

### 1. Field of the Invention

The present invention relates generally to a ribonucleic acid test panel and a ribonucleic acid test device, and more particularly to a ribonucleic acid test panel and a ribonucleic acid test device, which can shorten the test time and lower the cost.

### 2. Description of the Related Art

Currently, when it is desired to test the disease of a user, (such as Kawasaki disease, colorectal cancer, hand-foot-and-mouth disease, novel coronavirus (COVID-19) or other RNA carrying virus), it is necessary to send the user to a hospital and use a measure platform to make the mark, (such as a polymerase chain reaction (PCR) analyzer). Thereafter, it is necessary to take the user's blood and use an RNA extraction equipment to extract the miRNA virus. Then, the steps of adding miRNA, adding miRNA marking agent and dropping the miRNA marking agent onto the miRNA chip to dye and scan are sequentially performed. According to the brightness change of the luminescence and by means of comparing the data, it can be known whether the user is confirmatively infected. Therefore, conventionally, when testing the RNA (or miRNA) virus, a professional apparatus (such as measure platform or RNA extraction equipment) is needed. As a result, only a specific professional medical worker can operate these professional equipments so that the test difficulty and cost are high. In addition, conventionally, the virus is tested by means of luminescent marking. Such conventional test procedure is troublesome and complicated. Therefore, it takes at least two hours or even more than two days to have the test result. As a result, the test time is quite long.

### SUMMARY OF THE INVENTION

It is therefore a primary object of the present invention to provide a ribonucleic acid test panel, which can shorten the test time and lower the cost.

It is a further object of the present invention to provide a ribonucleic acid test panel, which can be easily operated and conveniently used.

It is still a further object of the present invention to provide a ribonucleic acid test device, which can shorten the test time and lower the cost.

It is still a further object of the present invention to provide a ribonucleic acid test panel, which can be easily operated and conveniently used.

To achieve the above and other objects, the ribonucleic acid test panel of the present invention includes a substrate, multiple sensation electrode layers, at least one primer layer and multiple electrode wiring layers. The substrate has a first surface and a second surface opposite to the first surface. The multiple sensation electrode layers are disposed on the first surface. The at least one primer layer is disposed on the multiple sensation electrode layers and insulated from each other. The at least one primer layer serves to react with a corresponding specimen containing ribonucleic acid. The multiple electrode wiring layers are disposed on the first surface and electrically connected with the multiple sensation electrode layers.

Still to achieve the above and other objects, the ribonucleic acid test device of the present invention includes a control unit and a ribonucleic acid test panel. The ribonucleic acid test panel includes a substrate, multiple sensation electrode layers, at least one primer layer and multiple electrode wiring layers. The substrate has a first surface and a second surface opposite to the first surface. The multiple sensation electrode layers are disposed on the first surface and electrically connected with the control unit. The at least one primer layer is disposed on the multiple sensation electrode layers and insulated from each other. The at least one primer layer serves to react with a corresponding specimen containing ribonucleic acid. The multiple electrode wiring layers are disposed on the first surface and electrically connected with the multiple sensation electrode layers and the control unit.

Therefore, by means of the design of the present invention, the test time is shortened and the cost is lowered. Moreover, a user himself/herself can quickly perform the test so that the test operation is simplified and the test can be quite conveniently performed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the ribonucleic acid test panel of the present invention;

FIG. 2A is a perspective assembled view of the first embodiment of the ribonucleic acid test panel of the present invention;

FIG. 2B is a sectional and partially enlarged view of the first embodiment of the ribonucleic acid test panel of the present invention;

FIG. 2C is a sectional and partially enlarged view of a modified embodiment of the first embodiment of the ribonucleic acid test panel of the present invention;

FIG. 3 is a perspective exploded view of a second embodiment of the ribonucleic acid test device of the present invention;

FIG. 4A is a perspective assembled view of a first aspect of the second embodiment of the ribonucleic acid test device of the present invention;

FIG. 4B is a top view of the second embodiment of the present invention according to FIG. 4A;

FIG. 5 is a perspective assembled view of a second aspect of the second embodiment of the ribonucleic acid test device of the present invention;

FIG. 6 is a perspective assembled view of a third aspect of the second embodiment of the ribonucleic acid test device of the present invention; and

FIG. 7 is a test result table of the specimen and the corresponding primer layer of the second embodiment of the ribonucleic acid test device of the present invention.

### DETAILED DESCRIPTION OF THE PREFERRED EMBODIMENTS

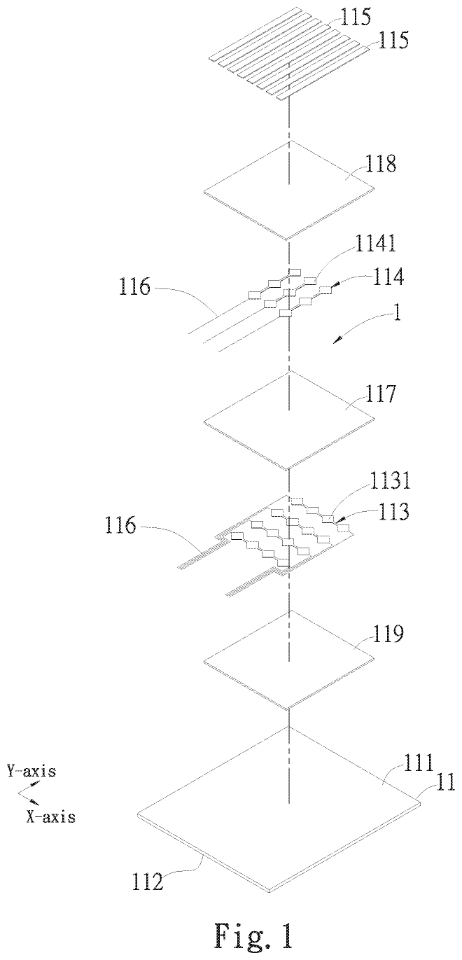

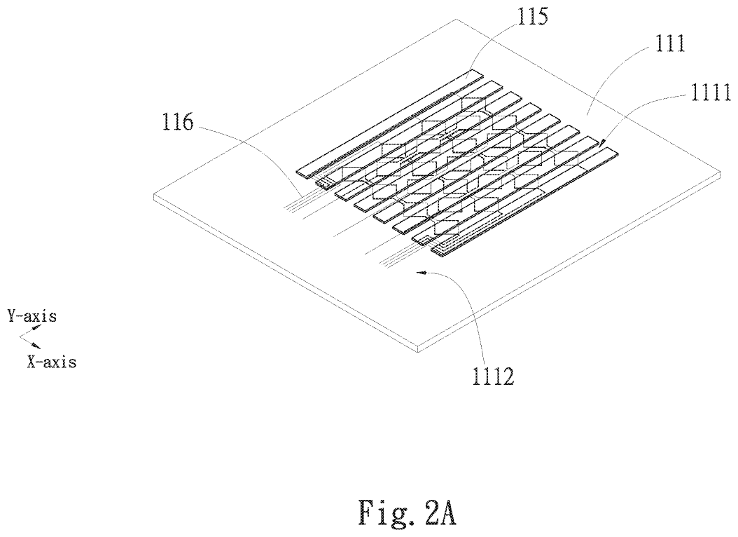

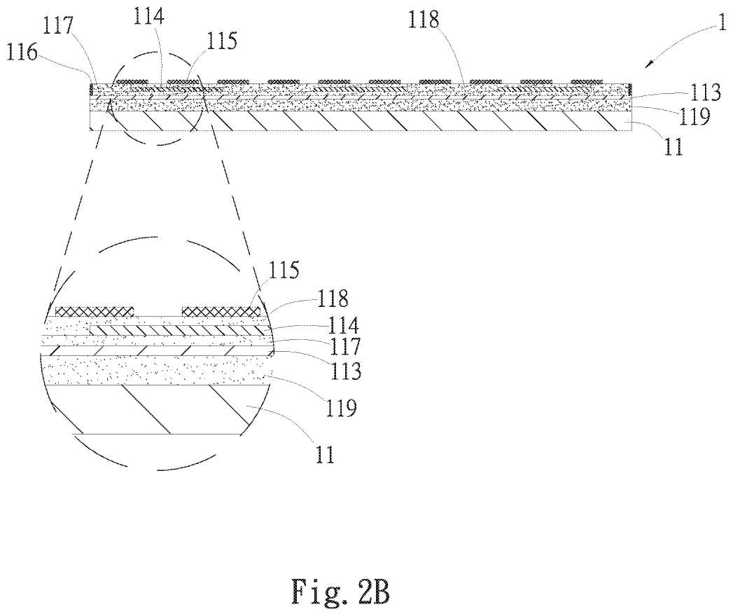

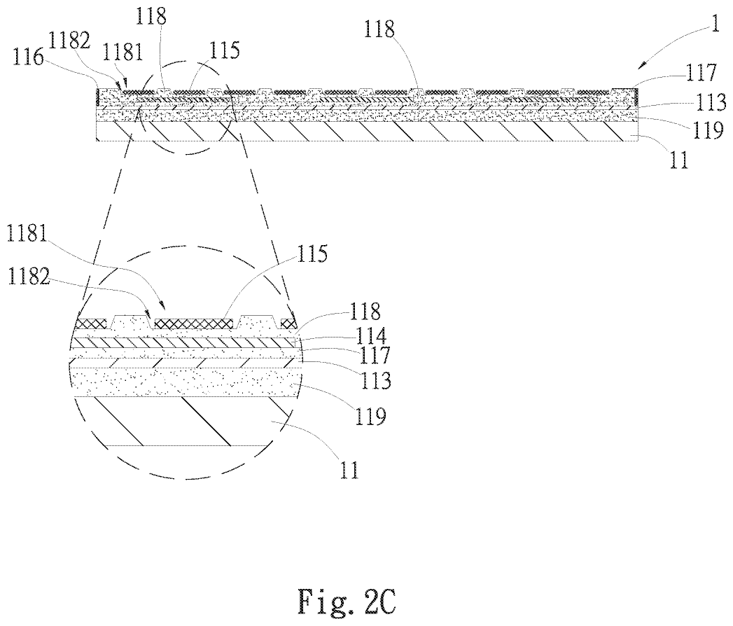

The present invention provides a ribonucleic acid test panel and a ribonucleic acid test device. Please refer to FIGS. 1 to 2C. FIG. 1 is a perspective exploded view of a first embodiment of the ribonucleic acid test panel of the present invention. FIG. 2A is a perspective assembled view of the first embodiment of the ribonucleic acid test panel of the present invention. FIG. 2B is a sectional and partially enlarged view of the first embodiment of the ribonucleic acid test panel of the present invention. FIG. 2C is a sectional and partially enlarged view of a modified embodiment of the first embodiment of the ribonucleic acid test panel of the present invention. As shown in FIGS. 1, 2A and 2B, the ribonucleic acid test panel 1 of the present invention includes a substrate 11, multiple sensation electrode layers, at least one primer layer 115 and multiple electrode wiring layers 116. The substrate 11 is a glass substrate 11, a circuit board 22 (such as flexible printed circuit board) or a polyethylene terephthalate (PET) substrate 11. In this embodiment, the substrate 11 is, but not limited to, a glass substrate 11 for illustration purposes. The substrate 11 has a first surface 111 and a second surface 112 opposite to the first surface 111. A sensation section 1111 is disposed on the first surface 111 of the substrate 11 and a peripheral section 1112 is disposed on the first surface 111 around the sensation section 1111. The multiple sensation electrode layers are disposed on the sensation section 1111 of the first surface 111. The multiple electrode wiring layers 116 are disposed on the peripheral section 1112 of the first surface 111. The multiple electrode wiring layers 116 are electrically connected with the multiple sensation electrode layers.

The multiple sensation electrode layers include a transparent or nontransparent first sensation electrode layer 113 and a transparent or nontransparent second sensation electrode layer 114. The first sensation electrode layer 113 has multiple first sensation electrodes 1131 (such as X-axis sensation electrodes) disposed in the sensation section 1111 of the first surface 111. The second sensation electrode layer 114 has multiple second sensation electrodes 1141 (such as Y-axis sensation electrodes) disposed on the first sensation electrode layer 113. In this embodiment, the multiple first and second sensation electrodes 1131, 1141 are respectively X-axis sensation electrodes and Y-axis sensation electrodes, which are arranged to intersect each other. The multiple sensation electrode layers and the multiple electrode wiring layers 116 are, but not limited to, made of a metal material selected from a group consisting of indium tin oxide (ITO), indium zinc oxide (IZO), antimony tin oxide (ATO) and any combination thereof. In practice, the metal material alternatively can be aluminum (Al), gold (Au), copper, silver (Ag), nickel (Ni), chromium (Cr) or any alloy thereof. In this embodiment, the multiple first and second sensation electrodes 1131, 1141 are, but not limited to, in a rhombus form. In a modified embodiment, the multiple first and second sensation electrodes 1131, 1141 alternatively can be in the form of a band, a strip, a wide band or a rectangle. In another modified embodiment, the multiple first sensation electrodes 1131 are arranged in the sensation section 1111 of the first surface 111 in a matrix or an array (such as M×N array) and the multiple second sensation electrodes 1141 are arranged on the first sensation electrode layer 113 in a matrix or an array (such as M×N array). In addition, the multiple first and second sensation electrodes 1131, 1141 are insulated from each other.

In another modified embodiment, the multiple first and second sensation electrodes 1131, 1141 of the first and second sensation electrode layers 113, 114 are correspondingly arranged on the first surface 111 of the substrate 11 in parallel to each other. The primer layer 115 is disposed on the first and second sensation electrode layers 113, 114 and insulated therefrom.

A first insulation layer 117 is disposed between the first and second sensation electrode layers 113, 114. The first insulation layer 117 is made of a material such as silicon dioxide (SiO2). The at least one primer layer 115 is formed and disposed on the multiple sensation electrode layers by means of such as printing or coating. The primer layer 115 is insulated from the multiple sensation electrode layers. In this embodiment, there are multiple primer layers 115 arranged on the second sensation electrode layer 114 at intervals. The primer layers 115 are made of polymer material for reacting with a corresponding specimen (such as the saliva of a user) carrying ribonucleic acid (or micro-ribonucleic acid). For example, in the case that the user's saliva, (that is, the RNA specimen) carries no RNA virus and cannot react and bond with the corresponding specific primer layer 115, there is no electrical change (such as no capacitance change or dielectric coefficient change). This is like the user's finger fails to touch such as the touch sensation section 1111 so that a constant coupling capacitance will exist between the multiple first and second sensation electrodes 1131, 1141 of the first and second sensation electrode layers 113, 114. At this time, the electrical field (electric field line) between the multiple first and second sensation electrodes 1131, 1141 is constant. In the case that the user's saliva, (that is, the RNA specimen) contains therein RNA virus and reacts and bonds with the corresponding specific primer layer 115, there is apparently electrical change (such as capacitance change or dielectric coefficient change). This is like the user's finger touches the touch sensation section 1111 so that a capacitance is formed between the primer layer 115 and the second sensation electrode layer 114. At this time, the electric field line is partially connected to the correspondingly primer layer 115 so that the electrical field (electric field line) originally constantly distributed between the multiple first and second sensation electrodes 1131, 1141 of the first and second sensation electrode layers 113, 114 will change, (that is, the electric field changes). Accordingly, the capacitance value of the coupling capacitance between the multiple first and second sensation electrodes 1131, 1141 will be changed, (that is, the capacitance value will change).

Moreover, the aforesaid primer layer 115 is a primer, which will only react with a corresponding specific virus (such as Kawasaki disease, colorectal cancer, hand-foot-and-mouth disease, novel coronavirus (COVID-19) or other RNA virus). For example, a specific primer is previously designed to detect such as novel coronavirus (COVID-19). In the case that the user's saliva, (that is, the specimen) contains therein novel coronavirus (COVID-19), the RNA novel coronavirus (COVID-19) will react and bond with the corresponding primer layer 115 for specifically detecting the novel coronavirus (COVID-19) and there is apparently electrical change. This means that the user is confirmed (positive) to have the novel coronavirus (COVID-19), (that is, infected with the virus). In the case that the user's saliva, (that is, the specimen) carries no virus or carries some other virus (such as Kawasaki disease), the virus will not react and bond with the corresponding primer layer 115 for specifically detecting the novel coronavirus (COVID-19) and there is no electrical change. This means that the user is not confirmed (negative) to have the novel coronavirus (COVID-19), (that is, not infected with the virus). The aforesaid primer is a small segment of single-chain DNA or RNA as a starting point for DNA reproduction. The primer exists in the natural creature for DNA reproduction (RNA primer) or is an artificial primer (generally DNA primer) produced in polymerase chain reaction (PCR) and composed of nucleotide.

A second insulation layer 118 is disposed between the multiple primer layers 115 and the second sensation electrode layer 114. A third insulation layer 119 is disposed between the first sensation electrode layer 113 and the substrate 11. The second and third insulation layers 118, 119 are made of a material such as silicon dioxide (SiO2). In a modified embodiment, the third insulation layer 119 can be omitted so that the first sensation electrode layer 113 is disposed on the first surface 111 of the substrate 11 (such as glass substrate or PET substrate).

The multiple primer layers 115 are such as in the form of elongated strip and positioned in the sensation section 1111 in X-axis direction (or Y-axis direction). The multiple primer layers 115 are arranged on the second insulation layer 118 at intervals through the intersections of the first and second sensation electrodes 1131, 1141. In a preferred embodiment as shown in FIG. 2C, multiple channels 1181 are formed on the second insulation layer 118 in positions corresponding to the multiple primer layers 115. The multiple primer layers 115 are received in the multiple channels 1181 of the second insulation layer 118. A micro-flow way 1182 is defined between each primer layer 115 and the inner wall of each corresponding channel 1181 for collecting the specimen (such as a user's saliva) so as to increase the contact area of the specimen and the corresponding primer layer 115 and effectively enhance the test precision and shorten the test time.

Therefore, by means of the design of the ribonucleic acid test panel 1 of the present invention, the test time is shortened and the cost is lowered. Moreover, a user himself/herself can quickly and readily test the condition of his/her body through the saliva. Therefore, the test operation is simplified and the test can be quite conveniently performed.

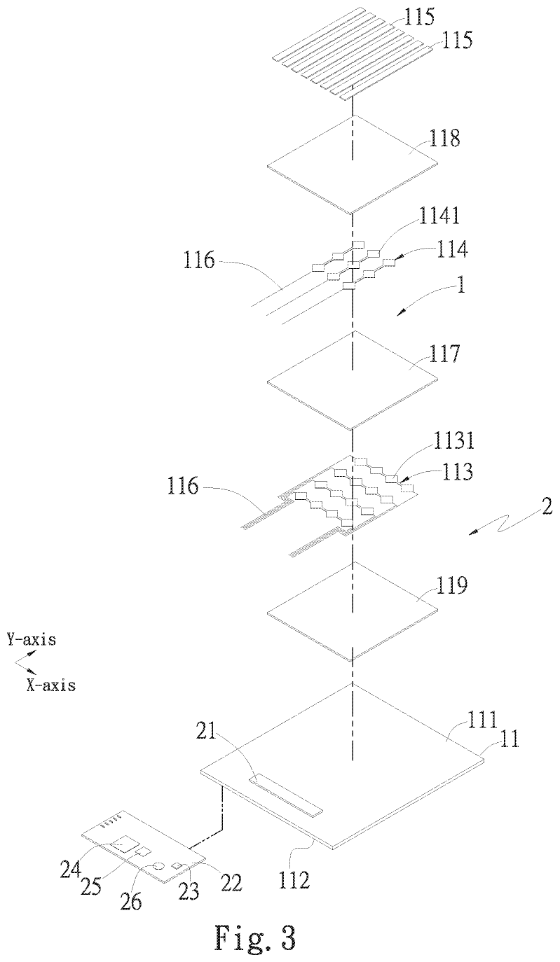

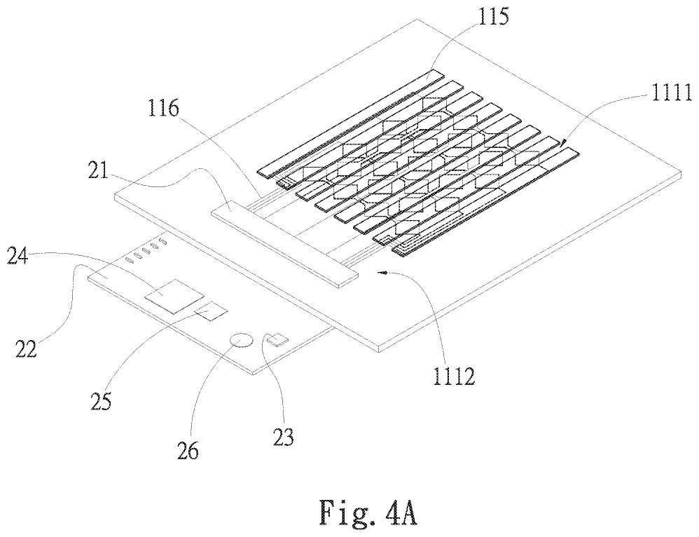

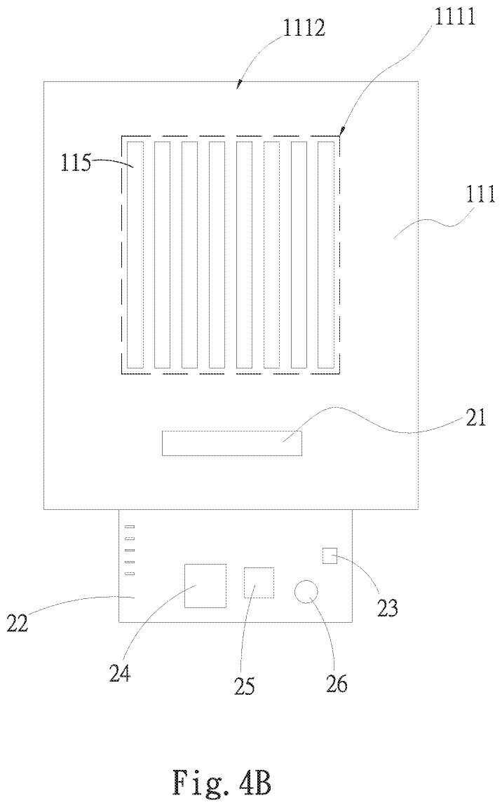

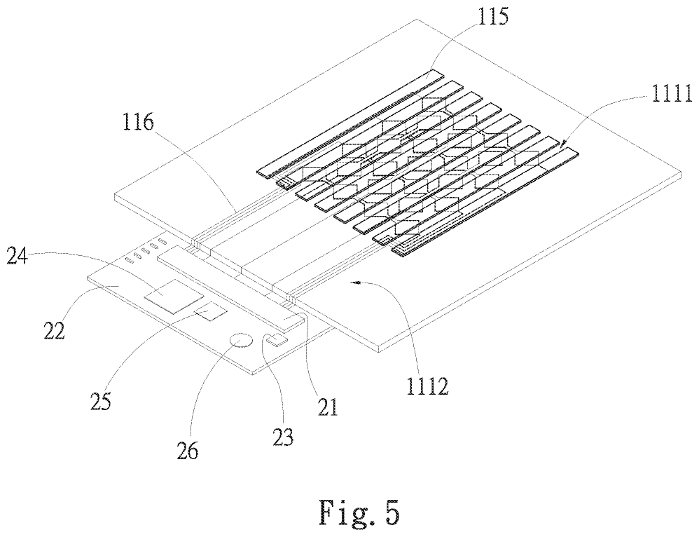

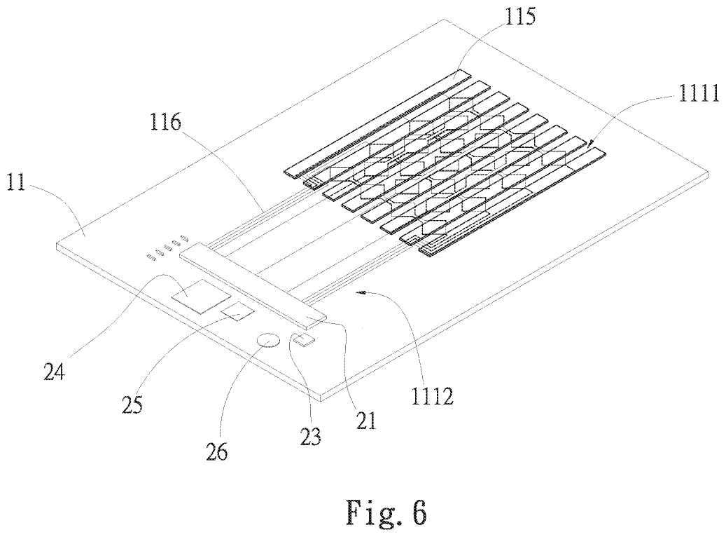

Please refer to FIGS. 3 to 6. FIG. 3 is a perspective exploded view of a second embodiment of the ribonucleic acid test device of the present invention. FIG. 4A is a perspective assembled view of a first aspect of the second embodiment of the ribonucleic acid test device of the present invention. FIG. 4B is a top view of the second embodiment of the present invention according to FIG. 4A. FIG. 5 is a perspective assembled view of a second aspect of the second embodiment of the ribonucleic acid test device of the present invention. FIG. 6 is a perspective assembled view of a third aspect of the second embodiment of the ribonucleic acid test device of the present invention. Also referring to FIG. 1, in this embodiment, the first embodiment of the ribonucleic acid test panel 1 of the present invention is applied to a ribonucleic acid test device 2. That is, the ribonucleic acid test device 2 of this embodiment includes a control unit 21 and a ribonucleic acid test panel 1. The structure and connection relationship and effect of the ribonucleic acid test panel 1 are identical to the structure and connection relationship and effect of the ribonucleic acid test panel 1 of the aforesaid first embodiment and thus will not be redundantly described hereinafter. The control unit 21 is a central processing unit (CPU), a microcontroller unit (MCU) or a digital signal processor (DSP). The control unit 21 is electrically connected with the multiple electrode wiring layers 116 and the multiple sensation electrode layers. The control unit 21 receives the capacitance change signal transmitted from the multiple sensation electrode layers, (that is, the multiple first and second sensation electrodes 1131, 1141) and judges whether there is electrical change of the specimen and the primer layer 115 according to the capacitance change signal to generate a test result. The test result can be that there is electrical change (such as capacitance value change) of the specimen and the primer layer 115 or there is no electrical change (such as no capacitance value change) of the specimen and the primer layer 115.

In this embodiment, the control unit 21 can be arranged in three aspects as follows:

In the first aspect, as shown in FIGS. 3, 4A and 4B, the control unit 21 is disposed on the peripheral section 1112 of the first surface 111 of the substrate 11 (such as glass substrate 11 or PET substrate 11). The control unit 21 is connected with the first surface 111 of the substrate 11 by means of chip-on-glass (COG). The control unit 21 is electrically connected with a circuit board 22 (such as a flexible printed circuit board, FPC) 22. The circuit board 22 is integrally connected with the substrate 11 by means of thermal press. A display member 23, a processing unit 24, a wireless transceiver unit 25 and a power supply unit 26 are disposed on the circuit board 22. The processing unit 24 is electrically connected with the control unit 21 and the display member 23 and the wireless transceiver unit 25. The processing unit 24 is such as a central processing unit (CPU), a digital signal processor (DSP) or a microcontroller unit (MCU) for processing and executing the signal. For example, in case the test result transmitted from the control unit 21 is there is electrical change, according to the test result, the processing unit 24 processes the signal to generate test result information and display the test result information (such as positive and case confirmed) via the display member 23. In case the test result transmitted from the control unit 21 is there is no electrical change, according to the test result, the processing unit 24 processes the signal to generate test result information and display the test result information (such as negative and case unconfirmed) via the display member 23. Therefore, from the display member 23, a user himself/herself can know whether he/she has confirmatively infected with the virus or not.

In this embodiment, the display member 23 is, but not limited to, a display for displaying the test result information. In a modified embodiment, the display member 23 is alternatively multiple light-emitting diodes (LED). That is, the test result is shown by means of multiple lights. For example, the red LED light is turned on to indicate positive and case confirmed, while the blue LED light is turned on to indicate negative and case unconfirmed. In this embodiment, the power supply unit 26 is a battery for supplying power to the display member 23, the processing unit 24, the wireless transceiver unit 25 and the ribonucleic acid test panel 1. In a preferred embodiment, the power supply unit 26 can be a rechargeable battery and a connection port (such as micro USB connection port) is disposed on the circuit board 22 for charging the power supply unit 26.

In this embodiment, the wireless transceiver unit 25 is a Bluetooth unit (such as Bluetooth transceiver). The Bluetooth unit is wirelessly connected to an electronic device (such as an intelligent mobile phone, an intelligent watch, a computer, a notebook or a tablet, which is not shown). Via the Bluetooth unit, the processing unit 24 wirelessly transmits the test result information to the electronic device to be shown. In practice, the wireless transceiver unit 25 is a Wi-Fi unit or a radiofrequency (RF) unit.

The second aspect is as shown in FIG. 5. The second aspect is different from the first aspect in that the control unit 21 is disposed on the circuit board 22. The control unit 21 is connected on the circuit board 22 by means of chip on flex (COF). The third aspect is as shown in FIG. 6. The third aspect is different from the second aspect in that the substrate 11 is a circuit board (or PET substrate) instead of the externally connected circuit board 22 of the second aspect. Therefore, the control unit 21, the processing unit 24, the display member 23, the wireless transceiver unit 25 and the power supply unit 26 are together disposed on the peripheral section 1112 of the same substrate 11 (or PET substrate 11). In addition, the sensation section 1111 of the substrate 11 is positioned near the center of the substrate 11.

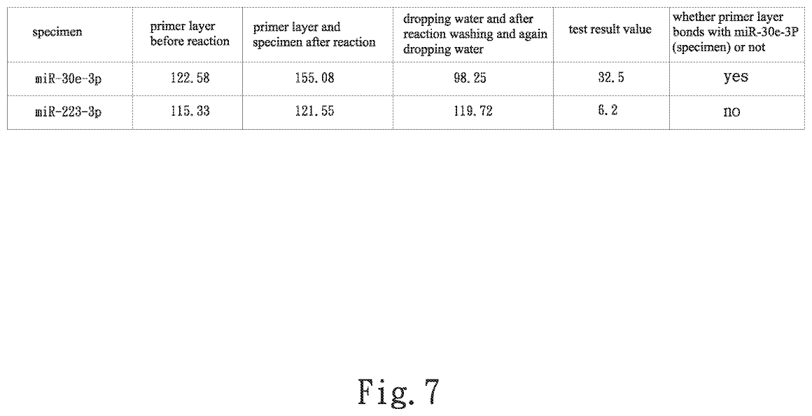

When a user desires to test the Kawasaki disease virus (or so-called mucocutaneous lymph node syndrome virus), the user can drop his/her saliva, (that is, the specimen) onto the sensation section 1111. In the case that the saliva contains the miRNA of the Kawasaki disease virus selected from miR-30e-3P, the miRNA of the Kawasaki disease virus will react and bond with the corresponding primer layer 115 for detecting the Kawasaki disease virus. Thereafter, there is apparently electrical change (such as capacitance change). According to the capacitance change signal transmitted from the multiple first and second sensation electrodes 1131, 1141, the control unit 21 judges that there is electrical change of the specimen and the primer layer 115 and generates the test result, which is transmitted to the processing unit 24. According to the test result that there is electrical change, the processing unit 24 processes the signal to transmit the test result information to the display member 23, whereby a user himself/herself can know the test result from the test result information displayed by the display member 23 (as shown in FIG. 7). In case the miRNA of the saliva of the user is miR-223-3P (without miRNA of the Kawasaki disease virus), the miRNA of the saliva of the user cannot react and bond with the corresponding primer layer 115 for detecting the Kawasaki disease virus. Therefore, there is no electrical change. According to the test result transmitted from the control unit 21 that there is no electrical change, the processing unit 24 processes the signal to transmit the test result information to the display member 23, whereby the user himself/herself can know the test result from the test result information displayed by the display member 23 (as shown in FIG. 7). FIG. 7 is a test result table of the specimen and the corresponding primer layer of the ribonucleic acid test device of the present invention. In the table, the corresponding test result value (such as 32.5) of the specimen miR-30e-3P is larger than the corresponding test result value (such as 6.2) of the specimen miR-223-3P. In this embodiment, a base value of the test result value, such as 15 is preset. That is, in case the test result value is equal to or larger than 15, this means the case is confirmed. In addition, the larger the test result value is, the longer the user's body carries the virus and the more serious the user's symptoms are. In case the test result value is smaller than 15, this means the case is unconfirmed.

Therefore, by means of the design of the ribonucleic acid test device 2 of the present invention, which tests the disease by means of electrical measure, the test time is effectively shortened such that the disease (such as disease virus) can be tested in fifteen minutes and the cost is lowered. Moreover, any user himself/herself can readily perform the test at home so that the test operation is simplified and the test can be quite conveniently performed.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A ribonucleic acid test panel comprising:
a substrate having a first surface and a second surface opposite to the first surface;
multiple sensation electrode layers disposed on the first surface;
at least one primer layer disposed on the multiple sensation electrode layers and insulated from each other, the at least one primer layer serving to react with a corresponding specimen containing ribonucleic acid; and
multiple electrode wiring layers disposed on the first surface and electrically connected with the multiple sensation electrode layers.

2. The ribonucleic acid test panel as claimed in claim 1, wherein a sensation section is disposed on the first surface of the substrate and a peripheral section is disposed on the first surface around the sensation section, the multiple sensation electrode layers being disposed on the sensation section of the first surface, the multiple electrode wiring layers being disposed on the peripheral section of the first surface.

3. The ribonucleic acid test panel as claimed in claim 2, wherein the multiple sensation electrode layers include a first sensation electrode layer and a second sensation electrode layer, the first sensation electrode layer being disposed on the sensation section of the first surface, the second sensation electrode layer being disposed on the first sensation electrode layer, a first insulation layer being disposed between the first and second sensation electrode layers.

4. The ribonucleic acid test panel as claimed in claim 3, wherein there are multiple primer layers arranged on the second sensation electrode layer at intervals, a second insulation layer being disposed between the multiple primer layers and the second sensation electrode layer.

5. The ribonucleic acid test panel as claimed in claim 4, wherein multiple channels are formed on the second insulation layer in positions corresponding to the multiple primer layers, the multiple primer layers being received in the multiple channels, a micro-flow way being defined between each primer layer and inner wall of each corresponding channel.

6. The ribonucleic acid test panel as claimed in claim 1, wherein the substrate is a glass substrate, a circuit board or a polyethylene terephthalate (PET) substrate.

7. The ribonucleic acid test panel as claimed in claim 1, wherein the at least one primer layer is formed on the multiple sensation electrode layers by means of printing or coating.

8. The ribonucleic acid test panel as claimed in claim 1, wherein the multiple sensation electrode layers and the multiple electrode wiring layers are made of a material selected from a group consisting of indium tin oxide (ITO), indium zinc oxide (IZO) and antimony tin oxide (ATO), the at least one primer layer being made of polymer material.

9. The ribonucleic acid test panel as claimed in claim 1, wherein the multiple sensation electrode layers and the multiple electrode wiring layers are made of a metal material selected from a group consisting of aluminum, gold, copper and silver.

10. A ribonucleic acid test device comprising:
a control unit; and
a ribonucleic acid test panel including:
a substrate having a first surface and a second surface opposite to the first surface;
multiple sensation electrode layers disposed on the first surface and electrically connected with the control unit;
at least one primer layer disposed on the multiple sensation electrode layers and insulated from each other, the at least one primer layer serving to react with a corresponding specimen containing ribonucleic acid; and
multiple electrode wiring layers disposed on the first surface and electrically connected with the multiple sensation electrode layers and the control unit.

11. The ribonucleic acid test device as claimed in claim 10, wherein the control unit is electrically connected with a circuit board, a display member 23, a processing unit 24, a wireless transceiver unit 25 and a power supply unit 26 being disposed on the circuit board 22, the processing unit being electrically connected with the control unit and the display member and the wireless transceiver unit, the power supply unit serving to supply power for the display member, the processing unit, the wireless transceiver unit and the ribonucleic acid test panel.

12. The ribonucleic acid test device as claimed in claim 11, wherein the wireless transceiver unit is a Bluetooth unit, a Wi-Fi unit or a radiofrequency (RF) unit.

13. The ribonucleic acid test device as claimed in claim 11, wherein the display member is multiple light-emitting diodes or a display, the control unit being a central processing unit, a microcontroller unit or a digital signal processor.

14. The ribonucleic acid test device as claimed in claim 11, wherein the control unit is disposed on the first surface of the substrate or the circuit board.

15. The ribonucleic acid test device as claimed in claim 10, wherein a sensation section is disposed on the first surface of the substrate and a peripheral section is disposed on the first surface around the sensation section, the multiple sensation electrode layers being disposed on the sensation section of the first surface, the multiple electrode wiring layers being disposed on the peripheral section of the first surface.

16. The ribonucleic acid test device as claimed in claim 10, wherein the multiple sensation electrode layers include a first sensation electrode layer and a second sensation electrode layer, the first sensation electrode layer being disposed on the sensation section of the first surface, the second sensation electrode layer being disposed on the first sensation electrode layer, a first insulation layer being disposed between the first and second sensation electrode layers.

17. The ribonucleic acid test device as claimed in claim 16, wherein there are multiple primer layers arranged on the second sensation electrode layer at intervals, a second insulation layer being disposed between the multiple primer layers and the second sensation electrode layer.

18. The ribonucleic acid test device as claimed in claim 17, wherein multiple channels are formed on the second insulation layer in positions corresponding to the multiple primer layers, the multiple primer layers being received in the multiple channels, a micro-flow way being defined between each primer layer and inner wall of each corresponding channel.

19. The ribonucleic acid test device as claimed in claim 10, wherein the substrate is a glass substrate, a circuit board or a polyethylene terephthalate (PET) substrate, the multiple sensation electrode layers and the multiple electrode wiring layers being made of a metal material selected from a group consisting of indium tin oxide (ITO), indium zinc oxide (IZO), antimony tin oxide (ATO), aluminum, gold, copper and silver, the at least one primer layer being made of polymer material.

20. The ribonucleic acid test device as claimed in claim 10, wherein the at least one primer layer is formed on the multiple sensation electrode layers by means of printing or coating.
